(19) United States
(12) Patent Application Publication
(10) Pub. No.: US 2014/0155089 A1
(43) Pub. Date: Jun. 5, 2014

(54) SYSTEM FOR MONITORING INSTALLED INFRASTRUCTURE

(71) Applicant: Sergio Ricardo Lopes Simões, São Caetano do Sul (BR)

(72) Inventor: Sergio Ricardo Lopes Simões, São Caetano do Sul (BR)

(73) Assignee: SS7 ASSESSORIA E CONSULTORIA LTDA, São Paulo (BR)

(21) Appl. No.: 14/239,187

(22) PCT Filed: Aug. 18, 2011
(86) PCT No.: PCT/IB2011/053650

§ 371 Date: Feb. 17, 2014

(51) Int. Cl. H04W 4/02

(52) U.S. Cl. CPC H04W 4/02
USPC 455/456.1

(57) ABSTRACT

The present patent of invention application relates to a system allowing monitoring and alarming several types of installed infrastructures, such as optical telephone closets, batteries, installed equipment, opening of environments doors and telephone closets, electrical and telephone cables. The need of that type of equipment is due to the large number of cables theft, mostly telephone ones, which causes, in addition to the loss for the providers, a great loss to society in general, as the lack of telecommunications and electrical services interrupts services in hospitals, government departments, banks, among others, causing great trouble.

The present patent application relates to a system allowing monitoring and alarming several types of installed infrastructures, such as optical telephone closets, batteries, installed equipment, opening of environments doors and telephone closets, electrical and telephone cables.

Particularly, the batteries may be monitored and tracked, i.e, the equipment allows locating the battery precisely, transmits that information via GPRS (GSM signal—mobile) to a monitoring center equipped with a software that handles those data, so as to allow perfect positioning on geopositioning maps (Google maps), thus making theft repression action easier.

The need of that type of equipment is due to the large number of cables theft, mostly telephone ones, and also batteries, which causes, in addition to the loss for the providers, a great loss to society in general, as the lack telecommunications and electrical services interrupts services in hospitals, government departments, banks, among others, causing great trouble.

### PRIOR ART

Systems currently used do not allow accurate location of cables cutting (theft) point, therefore, they do not offer clear information to a fast repression action.

As an example representing the state of the art, we may mention:

BR 9001955-5, related to an antitheft alarm system for telephone cables, working based on the emission a constant frequency, activating visual acoustic devices to indicate supervision, maintenance operation interruption for telephone cables. However, the application does not mention locating cables cutting points.

BR 0007309-1: describes a method allowing detecting and communicating failures in the line of a telephone communication system subscriber, at a connection section cabled between a subscriber unit and a subscriber terminal. However, the application does not disclose the indication of the exact footage, and its purpose is not fighting cables theft. Also, its installation is expensive, due to system complexity.

BR 0008537-5: relates to a system to locate a failure in an electric power transmission line having in it a first and a second terminal, wherein selected information related to the power signal are obtained at each terminal location in an electric power transmission line having several terminals. Safety relays are placed in the terminal locations and the information selected include the negative sequence current magnitude value and the power signal negative sequence magnitude and impedance angle, at about average failure in time. Automatic devices are provided to calculate, based on the negative sequence values, a fraction value M of total line length, representing the point in the line where the failure occurred, and devices to calculate the distance to the failure from the failure location calculation terminal, using the M value and the total distance between both terminals. However, this is a system designed only to power transmission lines, wherein relays are used to determine the lack of supply for system activation, which is thus different from the proposed system scope.

BR PI0601168-3: relates to a remote monitoring and controlling apparatus, in a constant and automatic way, for theft or violation of telephone or electric power cables and wires, for unauthorized opening of control panels, with the use of power provided only by the telephone cable itself concerning telephone systems, due to the project dedicated to telecommunications, using calculations and components for very low consumption, applied to telephone and electric power companies installations, intended to monitor thefts, sabotage and unauthorized access to closets, and applied in industries for remote process control and control of unauthorized opening of boards, and also in general for safety control of cables and wires, with hardware and software with on-line, real time control, bilateral communication, identification of the point where the violation occurred, identifying and monitoring, real time, services performance on closets or boards, doing events statistics, monitoring 24 hours, and with the possibility of being integrated to other safety systems, such as safety monitoring. However, the system works via DTMF cables (dials to a central unit); when it comes to theft, it does not show the exact point and neither how it detects the problem. Concerning powered cables, it does not comment operation.

The present system will be explained in detail with the help of the appended figures.

### BRIEF DESCRIPTION OF FIGURES

FIG. 1 schematically illustrates the system object of the present application.

FIG. 2 schematically shows the occurrence of a battery theft and the procedures followed according to the equipment object of the present application.

### DETAILED DESCRIPTION OF THE INVENTION

The present application primarily claims a supervision system capturing telephone cables impedance data on a passive way, i.e., with no generation of control signals in the line, or searching AC voltage values for monitoring electric or public lighting cables, or also resistance (continuity) values to check doors opening.

Some of the system's characteristics are:
Power supply: 110/220 V (60 Hz) consumption 250 mA or 48V DC consumption (30 mA)

Signal GPRS/GSM;
Maximum distance: About 10 km (telephone cables);
Resolution: 3 m;
Accuracy: +/−(20 m);
Monitoring software prepared to control points, generating visual and sound cut alarms, control reports and maps to make Last response teams action easier.

For installing the system, a couple of the cable to be monitored is required; that couple will make it possible to know the breaking point exactly, and therewith, the precise place is provided, so that the fast response teams may be fast and precisely set in motion. For electric cables it is also required to monitor an end of the network for the alarm to be started and the teams to be set in motion. For doors opening, on the other hand, it is only required to place a sensor at the door, which is interconnected with the equipment.

As the telephone cables may be monitored and the systems makes it possible to locate the cut exactly by indicating it through a system monitoring several parameters of the cables or of the other systems, transmits those information via GPRS (GSM signal—mobile) to a monitoring center provided with a software handling those data so as to allow perfect positioning in geopositioning maps (Google Maps, Maplink or Webraska), thus making theft repression action easier, for both cables and the other systems.

The system operation principle is based on:

1) Data collection: The equipment is installed at the point to be monitored, which may be telephone or electric cables, batteries or other systems;

2) The equipment will collect information related to correct operation of the monitored points, which are:
a. In telephone cables: Several impedances;
b. In electric cables: AC voltage;
c. In batteries: DC voltage;
d. In closet doors: Resistance (Continuity).

3) The equipment will collect the information and will transmit via GPRS/GSM the collected signals to a monitoring center;

4) That monitoring center, by means of a software, compares the data, and by means of mathematical functions, establishes correct values, acceptable values and values for alarm;

5) As the point is alarmed, the software is able to indicate, through maps, the points where the events occurred, concerning telephone cables, the alarm may also provide details of the footage where the cut occurred, increasing fast response efficacy.

6) The software also features the acquisition performance and signal quality reports (GPRS/GSM), making it possible to qualify the means to be alarmed and also the signal obtained.

7) In the monitoring center, the teams check the alarms conditions and set the fast response teams in motion, which will repress the theft.

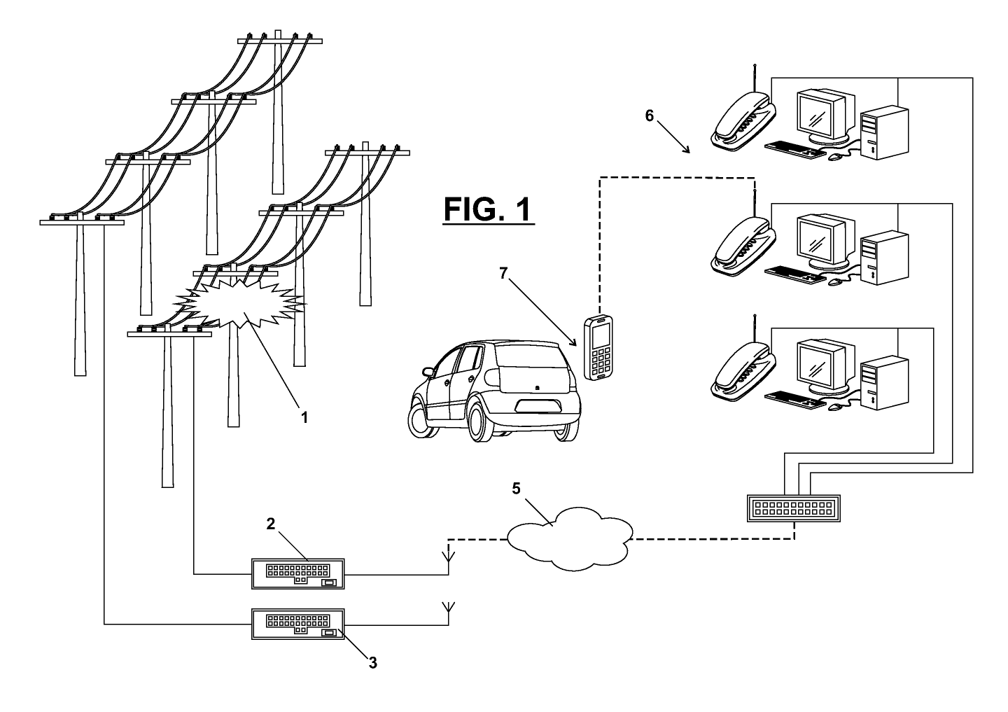

Based on FIG. 1, the present system operation is described, wherein when the occurrence of telephone cables theft is observed, the cut (1) positioning is detected by equipment (2) and (3), transmitted via GPRS-GSM (4), posting that information on the Internet (5). However, as the system works with fixed IP formats, that information is sent only to servers of the private monitoring center (6), which, by means of a software analyzing the values by means of mathematical functions, qualifies the event as normal or as alarm, and in case it is an alarm, the monitors operating the center contact the fast response teams (7) so that theft repression may be made for the infrastructure, in this example, telephone cables.

### Installation:

For equipment (2,3) installation for telephone wires cut detection, a couple is selected from any multicouple cable, and the whole monitoring is based on the values obtained in that couple, the whole trajectory may be outlined by connecting couples to that control pair, creating thus a single circuit that may be up to 10 km long.

Another aspect of the present invention handles batteries monitoring and tracking, and the batteries may be monitored and tracked, i.e., the equipment makes it possible to get the exact location of the battery, transmits that information via GPRS (GSM signal—mobile) to a monitoring center having a software handling those data in such a way to allow perfect positioning in geopositioning maps (Google Maps), thus making theft repression action easier.

### Batteries Monitoring

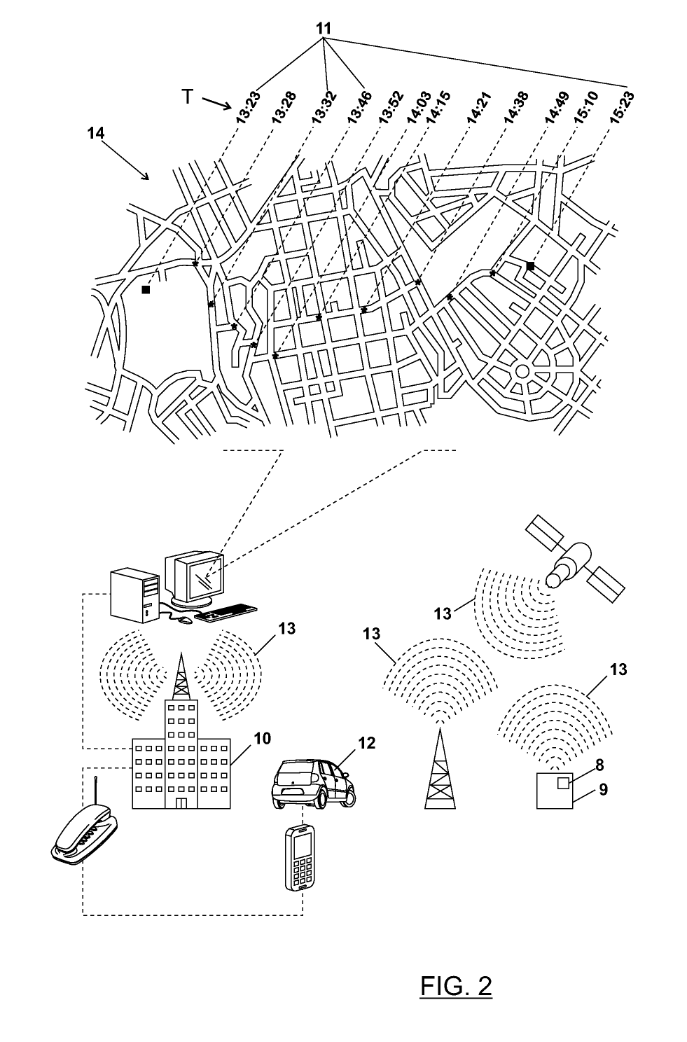

FIG. 2 shows the equipment operation principle, which is based on:

1) Data collection: The equipment (8) is installed in the battery (9) to be monitored. The equipment detects impedances (Resistive/Inductive/Capacitative), AC Voltage, DC Voltage, device movement and violation.

2) The equipment (8) will collect information related to battery operation (9); if the load capacity is correct, if it is moving or if it left an area that was previously registered as the correct operation place;

3) Every information collected will be transmitted via GPRS GSM and analyzed at a monitoring center (10), with positioning accuracy of about 15 meters. The equipment (8) transmits the collected data to a fixed IP;

4) That monitoring center (10), by means of a software, compare data, and by means of mathematical functions, establishes correct values, acceptable values and values for alarm;

5) As the point is alarmed, the software is able to indicate, through maps (14) (Google Maps or the like), the points (11) where the events occurred, as well as the time (T) the event occurred, the route the battery is following or has already followed along time;

6) The software also features the acquisition of performance and signal quality reports (GPRS/GSM), making it possible to qualify the means to be alarmed and also the signal obtained. The monitoring software is prepared for points control, generating alarms for low voltage, improper movement, safety fence violation and device violation.

7) In the monitoring center (10), the teams check the alarms conditions and set the fast response teams (12) in motion, which will repress the theft.

The monitoring and tracking equipment (8) is fed by the battery itself (9), and is hidden in its inside, but that does not change its external characteristic or weight, preventing, thus, the theft agent from easily identifying the battery with the monitoring device (8). In some cases, the voltage signal feeding the system shall be converted and adapted;

FIG. 2 shows an example of batteries theft event, wherein the initial battery positioning is transmitted via GPRS-GSM (13). The trajectory (11) made by the battery (9) may be observed, and the location not only of the battery, but also of the person who stole it may be verified, and the fast response team (12) may be sent to the place.

1. A system for monitoring installed infrastructure, wherein it comprises equipment (2) and (3), transmitting via GPRS-GSM (4) information to the Internet (5), said information sent only to the private monitoring center (6), which, by means of a software analyzing them and in case of alarm, the monitors operating the center contact the fast response team (7).

2. A system for monitoring installed infrastructure, according to claim 1, wherein it monitors:
a. in telephone cables: several impedances;
b. in electric cables: AC voltage;
c. in batteries: DC voltage; and
d. in closet doors: resistance (continuity).

3. A system for monitoring installed infrastructure, according to claim 1, wherein it comprises:
data collection by means of impedances detection (Resistive/Inductive/Capacitative), AC voltage and DC voltage, if the load capacity is correct, if the battery (9) is moving or if it left an area that was previously registered as the correct operation place, and also, if the device was violated;
every information collected is transmitted via GPRS/GSM (13) and analyzed in a monitoring center (10); the equipment (8) transmits the collected data to a fixed IP;
the monitoring center (10), by means of a software, compares data, and by means of mathematical functions, establishes correct values, acceptable values and values for alarm;
the software is able to indicate, by means of maps (14), the points (11) where the events occurred in time (T), the route the battery (9) is following or has already followed along time;
the software also features the acquisition of performance and signal quality reports (GPRS/GSM), making it possible to qualify the means to be alarmed and also the signal obtained, wherein the monitoring software is prepared for controlling points (116), generating alarms for low voltage, improper movement, safety fence violation and device violation;
the monitoring and tracking equipment (8) is fed by the battery itself (9).
